(19) United States
(12) Patent Application Publication
(10) Pub. No.: US 2011/0013909 A1
(43) Pub. Date: Jan. 20, 2011

(54) Optical Code Division Multiplexing Access System

(76) Inventors: Nobuyuki Kataoka, Tokyo (JP); Naoya Wada, Tokyo (JP); Gabriella Cincotti, Tokyo (JP); Xu Wang, Tokyo (JP); Kenichi Kitayama, Osaka (JP); Akira Sakamoto, Chiba (JP)

Correspondence Address: LAWRENCE Y.D. HO & ASSOCIATES PTE LTD, 30 BIDEFORD ROAD, #02-02, THONGSIA BUILDING, SINGAPORE, 229922, SG

(21) Appl. No.: 12/918,322

(22) PCT Filed: Feb. 19, 2009
(86) PCT No.: PCT/JP2009/000689

§ 371 Date: Sep. 28, 2010

(30) Foreign Application Priority Data
Feb. 20, 2008 (JP) 2008-039190

(51) Int. Cl. H04J 14/00

(52) U.S. Cl. 398/77

(57) ABSTRACT

Problem An object of the present invention is to provide an optical code division multiple access system which is used by many people.

Means for Solving The above problem is solved by an optical code division multiple access, OCDMA, system 5 which have a central office 2 comprising a multi-port optical encoder 1, a decode part 4 comprising a decoder 3 for decoding optical code signals from the multi-port optical encoder 1. The multi-port optical encoder 1 transform input optical signals into optical code signals the wavelength of them differs at predetermined amount based on code pattern. The decoder 3 is super structured fiber Bragg grating, SSFBG, which has center wavelength that corresponds to optical code signal.

### TECHNICAL FIELD

The present invention relates to an optical code division multiple access system.

### BACK GROUND OF ART

Optical code division multiple access (OCDMA) has unique features of full asynchronous transmission, low latency access, soft capacity on demand as well as optical layer security. Thus OCDMA is one promising technique for next-generation broadband access network. By combining OCDMA with wavelength division multiplexing (WDM) technique, high capacity in access networks can be achieved, which in prospective can enable gigabit-symmetric fiber-to-the-home (FTTH)

There are many different kinds of OCDMA encoder/decoders. For coherent time-spreading (TS) OCDMA, multi-port arrayed-waveguide-grating (AWG) OCDMA encoder/decoder has the unique capability of simultaneously processing multiple time-spreading optical codes (OCs) with single device (see following non-patent documents 1 and 2). Thus when the central office of the OCDMA network uses multi-port AWG encoder, the system may save the number of encoders and decoders. It is possible to reduce potential cost of the system even though cost of multi-port AWG encoder/decoder is expensive.

Usually, a decoder in the optical communication technology is a device that has symmetrical structure with its encoder. Thus if an optical system has a multi-port AWG encoder as an encoder, the system usually has a multi-port AWG decoder that has the same configures with the encoder. Multi-port AWG encoder and decoder are expensive. Thus if the system requests that the system for individual user has to equip a multi-port AWG decoder to decode signals, the system would not be prevail to citizens. Namely, even though a multi-port AWG encoder and a multi-port AWG encoder decoder have excellent characteristics, the users may be limited at least now.

### [Non-Patent Document 1]

G. Cincotti, N. Wada, and K.-i. Kitayama “Characterization of a full encoder/decoder in the AWG configuration for code-based photonic routers. Part I: modelling and design,” IEEE J. Lightwave Technol., vol. 24, n. 1, 2006.

### [Non-Patent Document 2]

N. Wada, G. Cincotti, S. Yoshima, N. Kataoka, and K.-i. Kitayama “Characterization of a full encoder/decoder in the AWG configuration for code-based photonic routers. Part IL experimental results” IEEE J. Lightwave Technol., vol. 24, n. 1, 2006

### DISCLOSURE OF INVENTION

### Problem to be Solved by the Invention

It is an object of the present invention to provide an optical code division multiple access (OCDMA) system that may be used by many users.

### Means for Solving the Problem

The present invention basically based on the new insight that the central office generates optical codes by means a multi-port AWG encoder and each client decodes the optical codes by means of decoder that has SSFBG. Then the OCDMA system may be used by many users.

The first aspect of the invention is directed to an optical code division multiple access system 5 that has a central office 2 that generates optical codes and a decode part 4 that decodes the optical codes. The central office 2 has a multi-port optical encoder 1 thereby it can generate optical codes. The decode part 4 has a decoder 3. The decoder 3 is configured to decode the optical codes.

The multi-port optical encoder 1 of the first aspect replaces the input optical signals into optical code signals that differs predetermined wavelength based on the code patterns. Specifically, the system may have an optical encoder disclosed in the above non-patent documents 1 and 2.

The decoder 3 of the first aspect is a super structured fiber Bragg grating (SSFBG) the center wavelength of which corresponds to the optical code signals. The term “the center wavelength of which corresponds to the optical code signals” is intended to mean that the grating reflects or passes the light that has predetermined wavelength and the predetermined wavelength is within the scope of the center wavelength of which corresponds to the optical code signals.

The system of the first aspect attains coding to generate optical signals the wavelength of which differs at predetermined amount based on the code patterns. Again, in this case, a previous system equips a decoder that has the same configuration with the encoder. The super structured fiber Bragg grating (SSFBG) encoder/decoder is known as an encoder/decoder for TS-OCDMA. The cost of SSFBG is low because SSFBG may be mass produced. Further SSFBG has the ability to process ultra-long TS-OC with polarization independent performance, low loss and code-length independent insertion loss. Thus when the OCDMA system has SSFBG as a decoder rather than a decoder that has a symmetrical structure with the encoder, the system may be used by many users.

A preferred embodiment of the first aspect of the present invention is that the multi-port optical encoder 1 comprises array waveguide grating (AWG) 10. The AWG 10 comprises pluralities of input ports 11, an input slab coupler 12, an output slab coupler 13, pluralities of wave-guides 14 and pluralities of output ports 15. The input slab coupler 12 is a slab wave-guide which is connected to pluralities of input ports 11. The output slab coupler 13 is a slab wave-guide in which the light from the input slab coupler 12 enters. The input slab coupler 12 and the output slab coupler 13 are optically connected through pluralities of wave-guides 14. The length of each of the wave-guides 14 differs at predetermined amount thus the wave-guides 14 can give time delay to optical signals that passes on the wave-guides based on the difference of length of the guide. The pluralities of output ports 15 are connected with the output slab coupler 13 and coded signals are output from the output slab coupler. The output port 15 is connected with the network.

The above described multi-port optical encoder is also called as a multi-port AWG encoder. A multi-port AWG encoder is a flexible encoder as introduced in the above non-patent documents 1 and 2.

A preferred embodiment of the first aspect of the present invention is that the multi-port optical encoder 1 comprises an array waveguide grating, AWG, 10. The AWG has pluralities of input ports 11, an input slab coupler 12, an output slab coupler 13, pluralities of wave-guides 14 and pluralities of output ports 15. The input slab coupler 12 is a slab wave-guide that is connected to pluralities of input ports 11. The output slab coupler 13 is a slab wave-guide in which the light from the input slab coupler 12 inputs. The input slab coupler 12 and the output slab coupler 13 are optically connected with each other through pluralities of wave-guides 14. The input slab coupler 12 and the output slab coupler 13 are optically connected through pluralities of wave-guides 14. The length of each of the wave-guides 14 differs at predetermined amount thus the wave-guides 14 can give time delay to optical signals that passes on the wave-guides based on the difference of length of the guide. The pluralities of output ports 15 are connected with the output slab coupler 13 and coded signals are output from the output slab coupler. The output port 15 is connected to the network.

Still preferred embodiment of the above meets the following conditions. Each of the wave-guides 14 has cores the refractive index of which is higher than that of clad. The clad surrounds the core. For following explanation the effective refractive index against the light that passes through the core of the wave-guide 14 is nₛ. The spacing between the pluralities of output ports 15 and the output slab coupler 13 is d₀ [μm]. The spacing between the pluralities of wave-guides 14 and the input slab coupler 12 is d [μm]. The center wavelength of the input optical signal is λ [nm]. The number of output ports 15 is N [unit].

When the spacing between the pluralities of input ports 11 and the input slab coupler 12 is dᵢ [μm], then dᵢ is equal to d₀. Further, the spacing between pluralities of wave-guides 14 and the pluralities of output slab coupler 13 is also d [μm]. When R is the focal length of the input slab coupler, the focal length of the output slab coupler is also R. Then λ, R, N, nₛ, d and d₀ meet the equation, λR=Nnₛdd₀.

Under the above condition the system can obtain optical codes effectively.

A preferred embodiment of the first aspect of the present invention is that the SSFBG comprises pluralities of chips. The chips of the SSFBG have periodical phase difference between neighboring chips such that SSFBG can execute time spreading and phase shift for each of the optical code signal.

Generally, a decoder has symmetrical structure with its encoder. Thus if an optical system has a multi-port AWG encoder as an encoder, the system usually has a multi-port AWG decoder that has the same configures with the encoder. Multi-port AWG encoder and decoder are expensive. Thus if the system requests that the system for individual user has to equip a multi-port AWG decoder to decode signals, the system would not be prevail to citizens. Thus the preferred embodiment of the present invention uses SSFBG which requires reasonable cost. The refractive index of chips should be controlled such that the decoder that comprises SSFBG can decode optical signals that are coded by the multi-port AWG encoder. Thereby, even though the cost of the SSFBG is reasonable, the multi-port AWG encoder can decode the optical code signal.

A preferred embodiment of the first aspect of the present invention is that the SSFBG comprises pluralities of chips. The pluralities of chips have phase so that they can reflect the light that has close center wavelength corresponding optical code signal selectively. Then the system can reflect the light that has close center wavelength corresponding optical code signal selectively. Similar to the above embodiment, the multi-port AWG encoder can decode the optical code signal.

The second aspect of the present invention relates to an optical code division multiple access system that has encode part that has an encoder, a central office that has a multi-port optical decoder that decodes the optical code signals that are coded by the encode part. The encoder is a super structured fiber Bragg grating (SSFBG) that has center wavelength corresponds to the multi-port optical decoder. The multi-port optical decoder can make input optical signals into the optical signals the wavelength of them differ at predetermined amount based on the code pattern. Further the decoder decodes the optical code signals.

Information in an optical code division multiple access (OCDMA) system may be down linked and up linked. The first aspect of the present invention is directed to the occasion that the information is down linked. However in the OCDMA system, the encoder in downlink can act as a decoder in uplink. Further, the decoder in the OCDMA system in down link can act as an encoder in uplink. Namely a decoder of OCDMA system in downlink may act as encoder in uplink. Thus in the second aspect of the present invention, it is possible to furnish configurations of the above explained the first aspect of the present invention. Then, user system may have encoder/decoder that has a small and cheap SSFBG and the central office has a multi-port decoder/encoder that can handle multi users even though the decoder/encoder is one device.

### TECHNICAL EFFECT

The central office of the present invention basically generates optical codes by means of a multi-port AWG encoder. Each client decodes using a decoder that comprises SSFBG. The central office can reduce number of expensive encoders by using an efficient multi-port AWG encoder even though the encoder is expensive. The cost of the multi-port AWG encoder can reduce when pluralities of user share the cost. Further, the present invention comprises an SSFGB, which is cheaper than a multi-port AWG encoder, as a decoder. Because the decoder equips cost-effective SSFBG the system can save cost for decoders. Then the system can increase the number of users. Thus present invention can provide the OCDMA system that is used by many people.

### THE BEST MODE FOR CARRYING OUT THE INVENTION

The present invention will be explained with figures. FIG. 1 is a block diagrams of the optical code division multiple access system of the present invention. As shown in FIG. 1, the first aspect of the invention is directed to an optical code division multiple access system 5 that has a central office 2 that generates optical codes and a decode part 4 that decodes the optical codes. The central office 2 has a multi-port optical encoder 1 thereby it can generate optical codes. The decode part 4 has a decoder 3. The decoder 3 has a SSFBG which is configured to decode the optical code signals. As shown in FIG. 1, the central office 2 and the decode part 4 are optically connected through an optical information network 6. Preferred example of the optical information network is that of star coupler type.

The multi-port optical encoder 1 of the first aspect replaces the input optical signals into optical code signals that differs predetermined wavelength based on the code patterns. Specifically, the system may have an optical encoder disclosed in the above non-patent documents 1 and 2.

FIG. 2 is a figure that depicts an example of a multi-port optical encoder of the present invention. As shown in FIG. 2, a preferred example of a multi-port optical encoder 1 of the present invention comprises an array waveguide grating (AWG) 10. The AWG10 comprises pluralities of input ports 11, an input slab coupler 12, an output slab coupler 13, pluralities of wave-guides 14 and pluralities of output ports 15. The input slab coupler 12 is a slab wave-guide which is connected to pluralities of input ports 11. The output slab coupler 13 is a slab wave-guide in which the light from the input slab coupler 12 enters. The input slab coupler 12 and the output slab coupler 13 are optically connected through pluralities of wave-guides 14. The length of each of the wave-guides 14 differs at predetermined amount thus the wave-guides 14 can give time delay to optical signals that passes on the wave-guides based on the difference of length of the guide. The pluralities of output ports 15 are connected with the output slab coupler 13 and coded signals are output from the output slab coupler. The output port 15 is connected with the network.

The light that inputs from input port 11 into the input slab coupler propagates the pluralities of waveguides 14. The length of the waveguides 14 gets longer at regular amount from inside to outside. The waveguide has a core that the refractive index of which is higher than that of base part. Because the refractive index of the core is higher than that of surrounding part, clad, it can prevent light that propagates on the waveguide from going out. The lights that pass each waveguides 14 reach the output slab coupler 13. During this, the lights obtain delay based on the difference of optical length of waveguides. At the output slab coupler 13, the light that propagates the waveguides 14 arrive as ripples. The light propagates with the top of ripples cancel out each other and reaches at the output part of the output slab coupler 13. Then there is an optical point where the intensity of light becomes largest at the output part. The place of the optical point differs based on the position of the input port and the wavelength of the input light. When the input signal is the light that has predetermined wavelength and an input port and an output port are different, the optical signal has different pattern. The difference of the pattern makes it possible to encode the optical signals.

The above multi-port optical encoder is called as a multi-port AWG encoder. As explained in the non-patented documents 1 and 2, the multi-port AWG encoder is a flexible encoder.

Preferred multi-port AWG encoder meets following conditions. The each of wave-guides 14 has cores the refractive index of which is higher than that of clad. The clad surrounds the core. For following explanation the effective refractive index against the light that passes through the core of the wave-guide 14 is nₛ. The spacing between the pluralities of output ports 15 and the output slab coupler 13 is d₀ [μm]. The distance between the pluralities of wave-guides 14 and the input slab coupler 12 is d [μm]. The center wavelength of the input optical signal is λ [nm]. The number of output ports 15 is N [unit].

When the spacing between the pluralities of input ports 11 and the input slab coupler 12 is dᵢ [μm], then dᵢ is equal to d₀. Further, the spacing between pluralities of wave-guides 14 and the pluralities of output slab coupler 13 is also d [μm]. When R is the focal length of the input slab coupler, the focal length of the output slab coupler is also R. Then λ, R, N, nₛ, d and d₀ meet the equation, λR=Nnₛdd₀.

Under the above condition the system can obtain optical codes effectively as explained in the non-patent documents 1 and 2.

FIG. 3 shows the outside view of a multi-port AWG encoder. This type of a multi-port AWG encoder and decoder forms a part of the state of the art as disclosed in non-patent documents 1 and 2. The activity of them is also disclosed therein.

FIG. 4 is a graph that shows an example of optical code signals generated by a multi-port AWG encoder. As shown in FIG. 4, the multi-port AWG encoder shown in FIG. 4 makes it possible to transform input optical signal into optical code signals the wavelength of them are different in a predetermined amount based on the code pattern.

The decode part 4 comprise a decoder 3. The decoder 3 has an SSFBG that can decode the optical code signals. The decode part 4 is a client that is connected with the central office through the network. Usually there are pluralities of decode parts 4.

When the input signal is coded by the above explained multi-port AWG encoder/decoder, the coded signal is easy to decode by using the multi-port AWG encoder/decoder. Namely, as explained above, to decode optical code signals the multi-port AWG decoder that has the same configuration shall be used. A signal is output as an auto-correlation signal if the signal passes through an input/output port that has the same configuration of an input/output port by which the signal was coded. When a signal passes an input/output port which is different from the input/output port by which the signal is coded, then cross-correlation signal is output. Because the waveform of auto-correlation and that of cross-correlation are completely different, it is easy to decode the signals.

However, the system of the present invention comprises an SSFBG which is configured to decode the optical code signals rather than comprising a multi-port AWG decoder. The SSFBG can encode/decode optical pulses by using optical phase codes. The SSFBG, for example, is an optical time-spreader that has a phase control means. The means expands an optical pulse into a group of chip pulses in time domain and the chip plusses are arranged on the time axis and the means generates and outputs a group of chip pulses.

The decoder 3 of the present invention is super structured fiber Bragg grating (SSFBG) the center wavelength of which corresponds to the optical code signal. The term “the center wavelength of which corresponds to the optical code signals” is intended to mean that the grating reflects or passes the light that has predetermined wavelength and the predetermined wavelength is within the scope of the center wavelength of which corresponds to the optical code signals.

The present invention equips an SSFBG as a factor of a decoder. However, the SSFBG originally acts as an encoder and a decoder.

The first aspect attains encoding by the optical signals the wavelength of them differs at predetermined amount based on the code patterns. In this case, the system usually equips the decoder that has the same configuration of an encoder. The super structured fiber Bragg grating (SSFBG) encoder/decoder is known as an encoder/decoder for TS-OCDMA. The cost of SSFBG is low because SSFBG may be mass produced. Further SSFBG has the ability to process ultra-long TS-OC with polarization independent performance, low loss and code-length independent insertion loss. Thus when the OCDMA system has SSFBG as a decoder rather than a decoder that has a symmetrical structure with the encoder, the system may be used by many users.

FIG. 5 depicts an example of a decoder that has an SSFBG. As shown in FIG. 5, the decoder 3 has optical fibers 21, 22, a circulator 23 in which the optical signal inputs, and an SSFBG 24. The SSFBG 24 is the SSFBG that has arranged pluralities of FBG units in a direction of optical propagate direction of the optical fiber. Following SSFBG is optical fiber type. Optical fiber comprises a core and a clad. The core is a wave-guide of the optical fiber. The SSFBG comprises pluralities of tandem FBG units arranged in a propagate direction or the core.

Unit FBG 25a, 25b, 25c, 25d . . . that compose the SSFBG 24 are corresponds to each chips of the optical codes. The code value of the SSFBG equipped in the usual OCDMA is determined by the phase relationship of the brag reflect light that is reflected at the neighboring unit FBG. The code value of the present invention is not only 0 and 1 but also minas value, the value between 0 and 1. For example, when neighboring chips have the same code values, the phase of the brag reflect light that reflects from corresponding unit FBG shall be the same. When neighboring chips have different code values, then the phase of the brag reflect light that reflects from corresponding unit MG shall be different.

A preferred embodiment of the first aspect of the present invention is that the SSFBG comprises pluralities of chips. The chips of the SSFBG have periodical phase difference with neighboring chips such that SSFBG can execute time spreading and phase shift for each of the optical code signal.

A preferred embodiment of the first aspect of the present invention is that the SSFBG comprises pluralities of chips. The pluralities of chips have phase so that they can reflect the light that has close center wavelength corresponding optical code signal selectively. Then the system can reflect the light that has close center wavelength corresponding optical code signal selectively. Similar to the above embodiment, even though the system equips a cheap SSFBG, the multi-port AWG encoder can decode the optical code signal. The wavelength of the optical codes generated by a multi-port optical encoder differs based on the code pattern. Thus when an SSFBG is used as a narrow band filter specialized in generated optical codes it is possible to extract a specific optical code. Thereby, it is possible to obtain a decoder with simple configuration.

Table 1 shows examples of 16 level phase sift SSFBG to optical signals that correspond with several center wavelength.

TABLE 1
16 level phase shift

| Code | Chip phase[rad] | Center Wavelength(nm) |
|---|---|---|
| Code 1 | π × (−8.125, −6.875,−5.625, −4.375, −3.125, −1.875, −0.625, | ‡ 1550.177 |
| | 0.625, 1.875, 3.125, 4.375, 5.625, 6.875, 8.125, 9.375, 10.625) | |
| Code2 | π × (−11.375, −9.625, −7.875, −6.125, −4.375, −2.625, | ‡ 1550.580 |
| | −0.875, 0.875, 2.625, 4.375, 6.125, 7.875, 9.625, 11.375, | |
| | 13.125, 14.875) | |
| Code3 | π × (−14.625, −12.375, −10.125, −7.875, −5.625, −3.375, | ‡ 1550.978 |
| | −1.125, 1.125, 3.375, 5.625, 7.875, 10.125, 12.375, 14.625, | |
| | 16.875, 19.125) | |
| Code4 | π × (−17.875, −15.125, −12.375, −9.625, −6.875, −4.125, | ‡ 1551.379 |
| | −1.375, 1.375, 4.125, 6.875, 9.625, 12.375, 15.125, 17.875, | |
| | 20.625, 23.375) | |

FIG. 6 is a graph that shows the optical transparency of SSFBG manufactured based on the examples of table 1. Arranging the phase of FBG units makes the optical light that has specific center wavelength reflect selectively. For example, when an encoder encodes input light such that it contains the above four center wavelength, the above calculated SSFBG can extract coded signals easily. Thereby the system can decode effectively without having a multi-port AWG decoder.

FIG. 7 shows one application of the OCDMA system of the present invention. The example realizes WDM, wavelength division multiplexing, —OCDMA. This example output multiplexed optical signal by n port WDM multiplexer, WDM-MUX. The output optical signals enter into m×m multi-port OCDMA encoder. The m×m multi-port OCDMA encoder is, for example, above explained multi-port AWG encoder. Input signal is encoded by the multi-port OCDMA encoder. The center wavelength of the optical code signal differs based on the coded pattern. The optical code signal arrives at a separate wave device through the network. The WDM-DEMUX, which is a branching wave device, separates based on the address of optical signals. The optical signals are directed to areas (LAN 1 . . . LANn), an example of the areas is LAN, in accordance with the addresses. The optical signals may be separated and propagates to the terminal apparatus (ONU) of each user in the area.

ONU act as a decode part. The decode part comprise a decoder that equips the SSFBG which corresponds to encoding of the multi-port encoder. For example, when optical code part encode optical signal in accordance with pattern OC₁, the ONU-1 that has the SSFBG corresponds to the pattern OC₁ can decode the signal. The preferred embodiment of the present invention is a communication system is WDM and OCDMA system.

The second aspect of the present invention relates to an optical code division multiple access system that has encode part that has an encoder, a central office that has a multi-port optical decoder that decodes the optical code signals that are coded by the encode part. The encoder is a super structured fiber Bragg grating (SSFBG) that has center wavelength corresponds to the multi-port optical decoder. The multi-port optical decoder can make input optical signals into the optical signals the wavelength of them differ at predetermined amount based on the code pattern. Further the decoder decodes the optical code signals.

Information in an optical code division multiple access (OCDMA) system may be down linked and up linked. The first aspect of the present invention is directed to the occasion that the information is down linked. However in the OCDMA system, the encoder in downlink can act as an encoder in uplink. Further, the decoder in the OCDMA system in down link can act as a decoder in up link. Namely a decoder of OCDMA system in downlink may act as encoder in uplink. Thus in the second aspect of the present invention, it is possible to furnish configurations of the above explained the first aspect of the present invention. Then, user system may have encoder/decoder that has a small and cheap SSFBG and the central office has a multi-port decoder/encoder that can handle multi users even though the decoder/encoder is one device.

### Example 1

### Performance of 16 Level Phase Shift SSFBG Encoder/Decoder

FIG. 8 shows a setup of experimental system for arranging optical signals of Example 1. The system obtains driving signal with 9.95328 GHz by means of synthesizer. The system enters the driving signal into a mode lock laser diode. Thus the system obtains pulse signals of 1.8 ps. The system enters the driving signal (C192) into a pulse pattern generator (PPG) and a bit error tester (BERT) as clock signals. EDFA may amplitude the output light from the mode lock laser diode. The light enters phase modulator, PM, through a phase controller, PC. Bias Voltage is applied to the phase modulator. The driving signals from PPG are also added to the phase modulator. The output signal from the phase shifter may be amplified and enter an encoder though a filter and a polarizing controller.

FIG. 9 is a picture to show an example of outside view of the multi-port AWG encoder that is used in the Example 1. The multi-port AWG encoders shown in FIGS. 2 and 3 are used as the multi-port AWG encoder. Specifically, the system equips 16-chip multi-port AWG encoder that comprises waveguides on the planer light wave circuit. The pulse interval was 5 ps and chip rate was 200 G chip/s. Optical signals from port 1 through port 8 have time delay of 0, 5, 10 . . . 80 ms, respectively.

The detective system arranged the optical intensity for each wavelength by optical variable attenuator, VOA. Then the signals are separated at Mach-Zehnder interferometer and the light that propagates one arm got 93 ps time delay. Then, the system executed balanced detection using dual pin photodiode. BERT measured BER after the light passed low pass filter.

FIG. 10 shows the experimental setup of Example 1. The elements that are depicted in FIG. 8 are not explained again. The system of FIG. 10 used an SSFBG as an encoder. The SSFBG was 16 chips and 16 phase levels. As shown in table 1, we arranged the phase of each chips based on the central wavelength of light that passes each chips. FIG. 11 is the picture that shows an outside view of the SSFBG used in Example 1.

In this experiment, we prepared four uniform index change 16-chip SSFBG decoders (FBGs 1-4). These FBG has 6 input ports and 16 output ports. The center wavelength is 1551 nm, chip length is ˜0.52 mm, total length of grating is 8.32 mm, and the 16 phase levels are generated by shifting the chip grating by a step of +/−λ/8. Two 16-level phase shift patterns were used for these gratings: the pattern for FBG 1 and FBG2 is OC-1 and for FBG 3 and FBG4 is OC-2; OC-1 and OC-2 correspond to the OCs generated from the multi-port encoder with input port 8, output ports 3 and 7, respectively

FIG. 12 is a graph that shows wave form of the input pulse. FIG. 13A to FIG. 13 C are graphs that show optical codes encoded by FBG of pattern OC-1 and optical codes encoded by an AWG encoder that is an encoder which equips with an AWG. FIG. 13A is a graph that shows an optical signal encoded by FBG1. FIG. 13A is a graph that shows an optical signal encoded by FBG2. FIG. 13A is a graph that shows an optical signal encoded by an AWG encoder. FIG. 14A to FIG. 14 C are graphs that show optical codes encoded by FBG of pattern OC-2 and optical codes encoded by an AWG encoder that is an encoder which equips with an AWG. FIG. 14A is a graph that shows an optical signal encoded by FBG3. FIG. 14A is a graph that shows an optical signal encoded by FBG4. FIG. 14A is a graph that shows an optical signal encoded by an AWG encoder.

As shown in FIG. 13A, the duration of the generated OCs was ˜80 ps and chip-rate was 200 G chip/s. The temporal waveforms of the encoded signals from SSFBG are different as those from AWGs mainly because that we focused on phase shift pattern here and used uniform gratings. The temporal waveform of the generated signal could be further tailored by carefully design the index change along the whole grating.

As shown in FIGS. 14A to 14C, the peaks of each individual chips of OC-2 generated from SSFBG are not as clear as OC-1 and that from the AWG.

FIGS. 15A to 15D are graphs that show waveforms of the auto-correlation with various combinations of an SSFBG of pattern OC-1 and AWG. FIG. 15A is a graph for the case that the system comprises AWGs as both an encoder and a decoder. FIG. 15B is a graph for the case that an encoder and a decoder comprise FBG1 and FBG2, respectively. FIG. 15C is a graph for the case that both of encoder and decoder comprise AWG and FBG2. FIG. 15D is a graph for the case that both of encoder and decoder comprise AWG and FBG1.

FIGS. 16A to 16D are graphs that show waveforms of the auto-correlation with various combinations of an SSFBG of pattern OC-1 and AWG. FIG. 16A is a graph for the case that the system comprises AWGs as both an encoder and a decoder. FIG. 16B is a graph for the case that an encoder and a decoder comprise FBG3 and FBG4, respectively. FIG. 16C is a graph for the case that both of encoder and decoder comprise AWG and FBG3. FIG. 16D is a graph for the case that both of encoder and decoder comprise AWG and FBG4.

As shown in FIGS. 15A to 15D and 16A and 16D, the waveforms of the auto-correlation with different combinations of AWG and SSFBG encoder/decoders are quit similar. It shows that any combination of the AWG and SSFBG encoder/decoder can work correctly.

FIG. 17 (FIGS. 17A and 17B) is a graph that shows the comparison of power contrast ratios of auto- to cross-correlation (PCRs) for AWG and SSFBG decoders. FIG. 17A is a graph that compares AWG and SSFBG of pattern OC-1. FIG. 17B is a graph that compares AWG and SSFBG of pattern OC-2. Both of the systems in FIGS. 17A and 17 B have an AWG encoder as an encoder. Comparing to a pair of AWG-based encoder/decoder, the AWG encoder and SSFBG decoders have the similar performance but generally 1˜5 dB lower.

Considering that the FBG1 to FBG4 are uniform and there was obvious imperfectness in the fabrication, these results are reasonably good. Moreover, SSFBG decoder is very robust to the temperature change. In the experiment, with 2˜2.5° C. temperature change of the AWG encoder, the changes of PCR are within 1 dB. These performances verify the feasibility of hybrid using multi-port AWG-type encoder and multi-phase-level phase-shifted SSFBG decoder to enable flexible and cost-effective OCDMA network. Performance is expected to be further improved by using non-uniform SSFBGs.

FIG. 18 shows the experimental setup that comprises SSFBGs as an encoder and a decoder.

### Example 2

### Multi-User OCDMA Experiment

FIG. 19 shows the block diagram of the experimental setup to demonstrate 10 Gbps, 8-user DPSK OCDMA using hybrid multi-port AWG encoder/SSFBG decoder.

FIG. 20 (FIGS. 20A-20F) is a graph that shows the waveforms, spectra and eye diagrams measured at different points in the experiment. FIG. 20A is the graph at the point alpha, α. FIG. 20B is the graph at the point beta, β. FIG. 20C is the graph at the point gamma, γ. FIG. 20D is the graph at the point pi, π. FIG. 20E is the graph at the point theta, θ. FIG. 20F is the graph at the point xi, ξ.

The mode-lock laser diode (MLLD) generated ˜1.8 ps optical pulses at repetition rate of 9.95328 GHz (OC192) with central wavelengths of 1550.8 nm. The signal was modulated with differential-phase-shift-keying (DPSK) format by Lithium Niobate phase modulator (LN-PM) (point α in the figure). The data were 2²³−1 pseudo random bit sequence (PRBS).

The signal went to the port number 8 of the 16×16 ports AWG encoder and generated eight different OCs (point β of FIG. 19). These 8 signals were mixed in a truly asynchronous manner with equal power, random delay, random bit phase and random polarization states emulating 8×10 Gbps asynchronous OCDMA network (point γ of FIG. 19). The measurements were done under one of the worst-case scenario, which is bit synchronous and polarization aligned.

At the receiver, the 16-chip, 16-level phase-shifted SSFBG decoder decoded the received multiplexed OCDMA signal for a target OC (point π of FIG. 19). A fiber based interferometer and balanced detector performed the DPSK detection (point θ of FIG. 19). The data were recovered by the clock-data-recovery (CDR) circuit (point ξ of FIG. 19) and measured by bit-error-rate tester (BERT). As shown in FIGS. 20E and 20F, for 8-user OCDMA, very clear eye opening can be observed from θ and ξ.

FIG. 21 is a graph that shows the measured BER performances for single- (K=1) and eight-user (K=8) with different SSFBG decoder. In the figure, an open circle corresponds to back to Back after phase modulation. Closed square corresponds to 1 user case using G1429 (Code 1) as an encoder. Open square corresponds to 8 user case using G1429 (Code 1) as an encoder. Closed lozenge corresponds to 1 user case using G1430 (Code 2) as an encoder. Open lozenge corresponds to 8 user case using G1430 (Code 2) as an encoder. Closed triangle corresponds to 1 user case using G1431 (Code 2) as an encoder. Open triangle corresponds to 8 user case using G1431 (Code 2) as an encoder. The x corresponds to 1 user case using G1433 (Code 2) as an encoder and 8 user case using G1433 (Code 2) as an encoder. Error free has been achieved for all the four decoders in both cases. About 4 dB power penalty has been observed at BER=10⁻⁹ for K=8 OCDMA compared to K=1.

### INDUSTRIAL APPLICABILITY

The present invention involves in the technical field of an optical information communication.

### BRIEF EXPLANATION OF FIGURES

FIG. 1 is a block diagrams of the optical code division multiple access system of the present invention.

FIG. 2 is a figure that depicts an example of a multi-port optical encoder of the present invention.

FIG. 3 shows the outside view of a multi-port AWG encoder.

FIG. 4 is a graph that shows an example of optical code signal spectrum generated by a multi-port AWG encoder.

FIG. 5 depicts an example of a decoder that has an SSFBG.

FIG. 6 is a graph that shows the optical transparency of SSFBG manufactured based on the examples of table 1.

FIG. 7 shows one application of the OCDMA system of the present invention.

FIG. 8 shows a setup of experimental system for arranging optical signals of Example 1.

FIG. 9 is a picture to show an example of outside view of the multi-port AWG encoder that is used in the Example 1.

FIG. 10 shows the experimental setup of Example 1.

FIG. 11 is the picture that shows an outside view of the SSFBG used in Example 1.

FIG. 12 is a graph that shows wave form of the input pulse.

FIG. 13A to FIG. 13 C are graphs that show optical codes encoded by FBG of pattern OC-1 and optical codes encoded by an AWG encoder that is an encoder which equip s with an AWG. FIG. 13A is a graph that shows an optical signal encoded by FBG1.

FIG. 13A is a graph that shows an optical signal encoded by FBG2. FIG. 13A is a graph that shows an optical signal encoded by an AWG encoder.

FIG. 14A to FIG. 14 C are graphs that show optical codes encoded by FBG of pattern OC-2 and optical codes encoded by an AWG encoder that is an encoder which equip s with an AWG. FIG. 14A is a graph that shows an optical signal encoded by FBG3.

FIG. 14A is a graph that shows an optical signal encoded by FBG4. FIG. 14A is a graph that shows an optical signal encoded by an AWG encoder.

FIGS. 15A to 15D are graphs that show waveforms of the auto-correlation with various combinations of an SSFBG of pattern OC-1 and AWG. FIG. 15A is a graph for the case that the system comprises AWGs as both an encoder and a decoder. FIG. 15B is a graph for the case that an encoder and a decoder comprise FBG1 and FBG2, respectively. FIG. 15C is a graph for the case that both of encoder and decoder comprise AWG and FBG2. FIG. 15D is a graph for the case that both of encoder and decoder comprise AWG and FBG1.

FIGS. 16A to 16D are graphs that show waveforms of the auto-correlation with various combinations of an SSFBG of pattern OC-1 and AWG. FIG. 16A is a graph for the case that the system comprises AWGs as both an encoder and a decoder. FIG. 16B is a graph for the case that an encoder and a decoder comprise FBG3 and FBG4, respectively. FIG. 16C is a graph for the case that both of encoder and decoder comprise AWG and FBG3. FIG. 16D is a graph for the case that both of encoder and decoder comprise AWG and FBG4.

FIG. 17 (FIGS. 17A and 17B) is a graph that shows the comparison of power contrast ratios of auto- to cross-correlation (PCRs) for AWG and SSFBG decoders. FIG. 17A is a graph that compares AWG and SSFBG of pattern OC-1. FIG. 17B is a graph that compares AWG and SSFBG of pattern OC-2.

FIG. 18 shows the experimental setup that comprises SSFBGs as an encoder and a decoder.

FIG. 19 shows the block diagram of the experimental setup to demonstrate 10 Gbps, 8-user DPSK OCDMA using hybrid multi-port AWG encoder/SSFBG decoder.

FIG. 20 (FIGS. 20A-20F) is a graph that shows the waveforms, spectra and eye diagrams measured at different points in the experiment. FIG. 20A is the graph at the point alpha, α. FIG. 20B is the graph at the point beta, β. FIG. 20C is the graph at the point gamma, γ. FIG. 20D is the graph at the point pi, π. FIG. 20E is the graph at the point theta, θ. FIG. 20F is the graph at the point xi, ξ.

FIG. 21 is a graph that shows the measured BER performances for single- (K=1) and eight-user (K=8) with different SSFBG decoder.

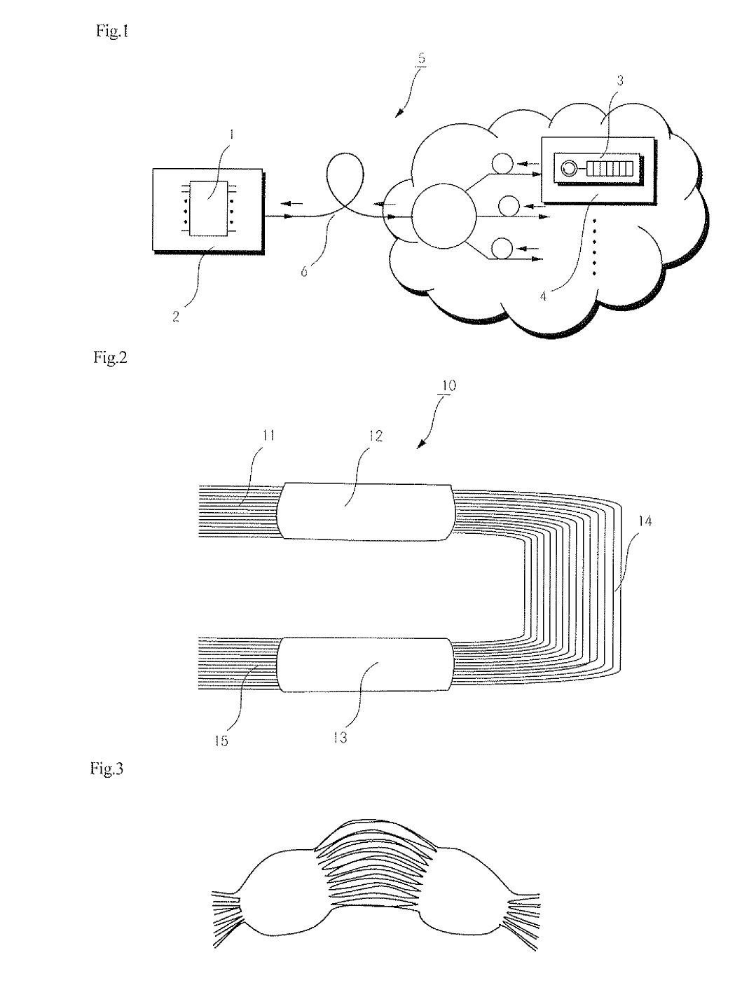

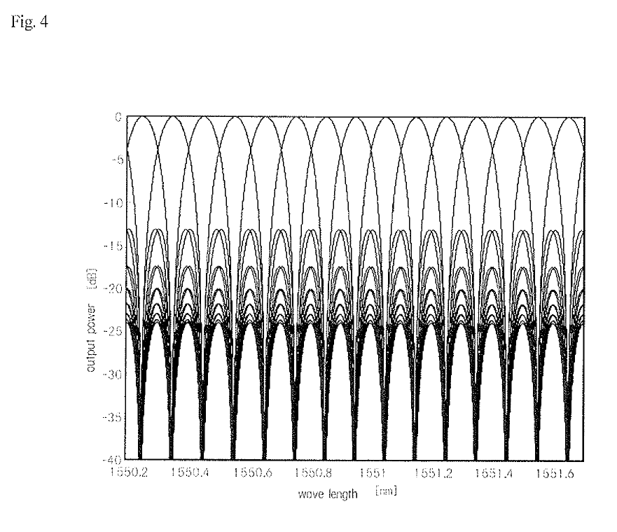

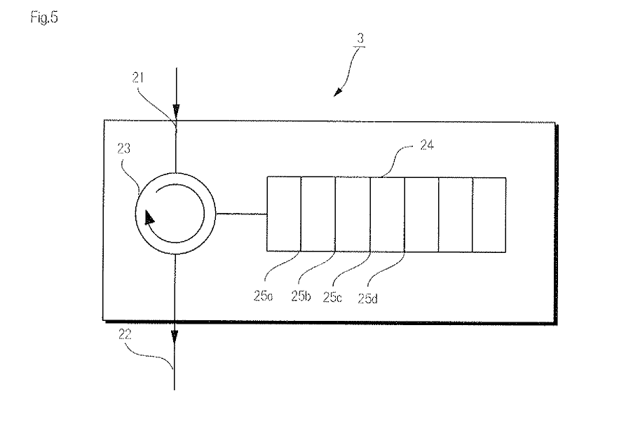

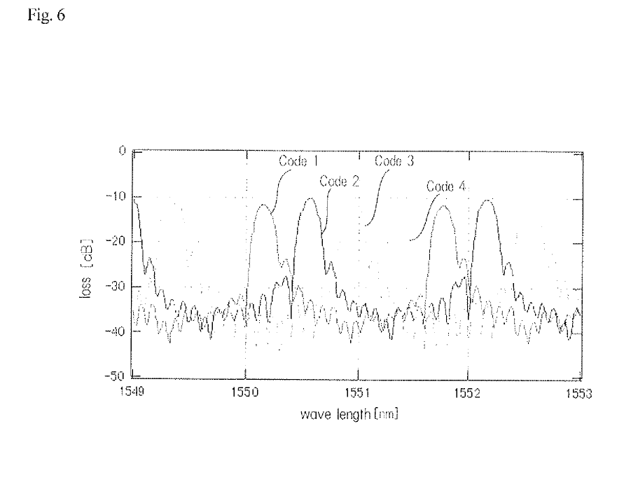

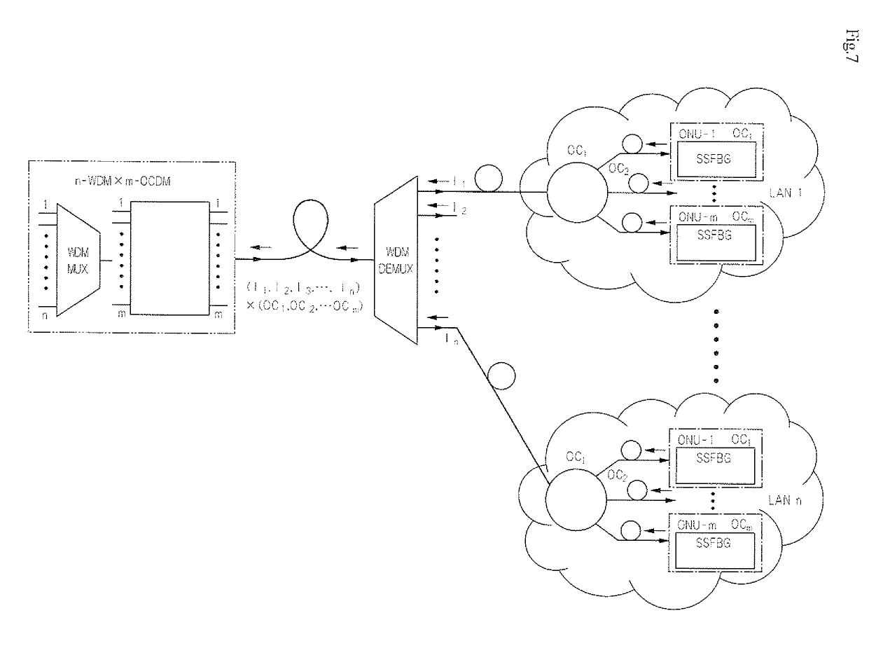

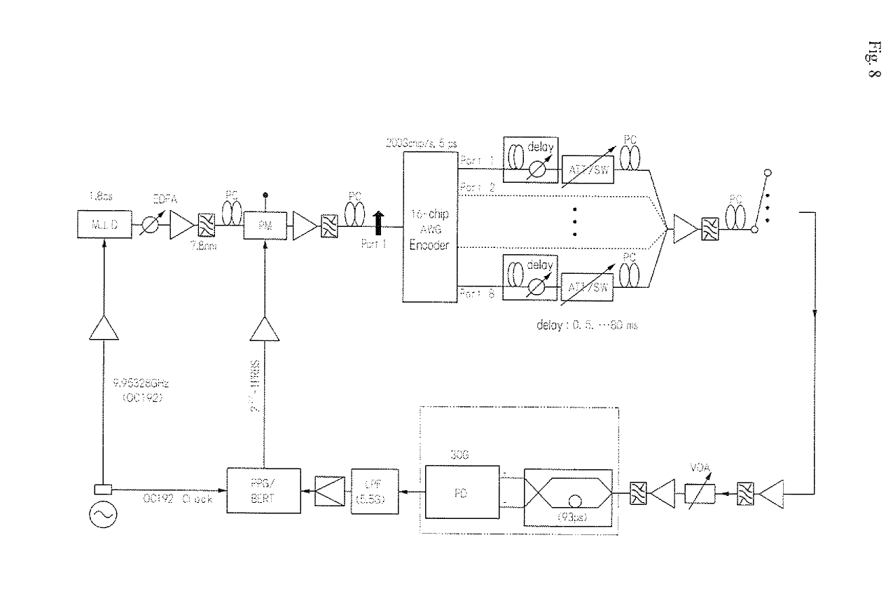

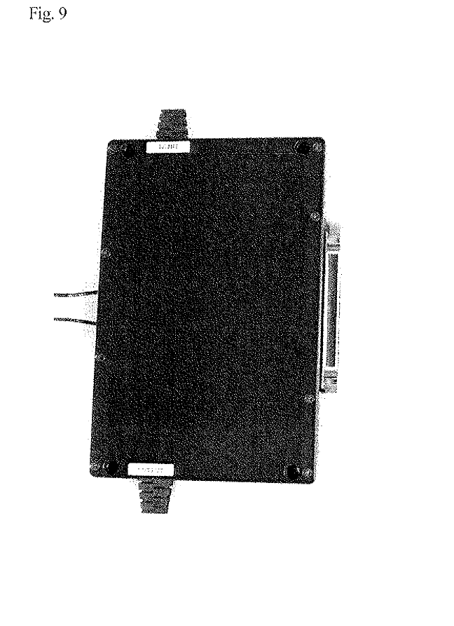

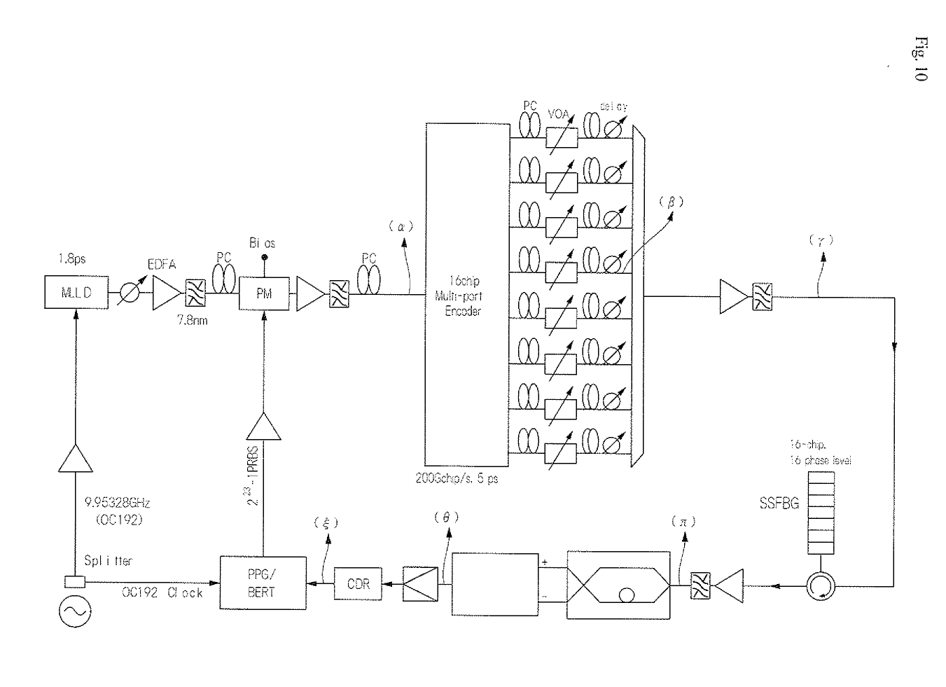

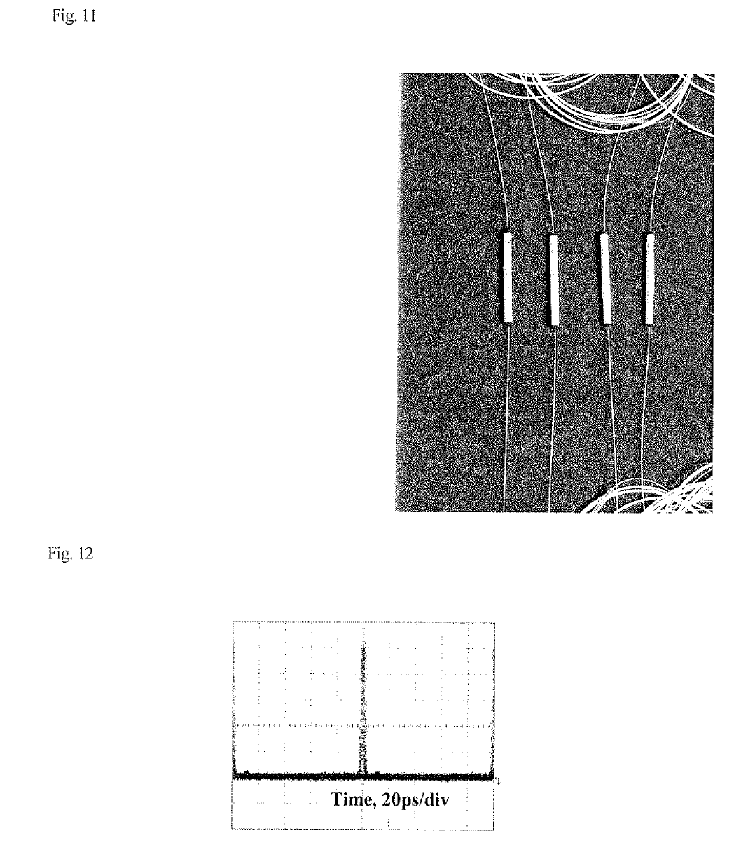

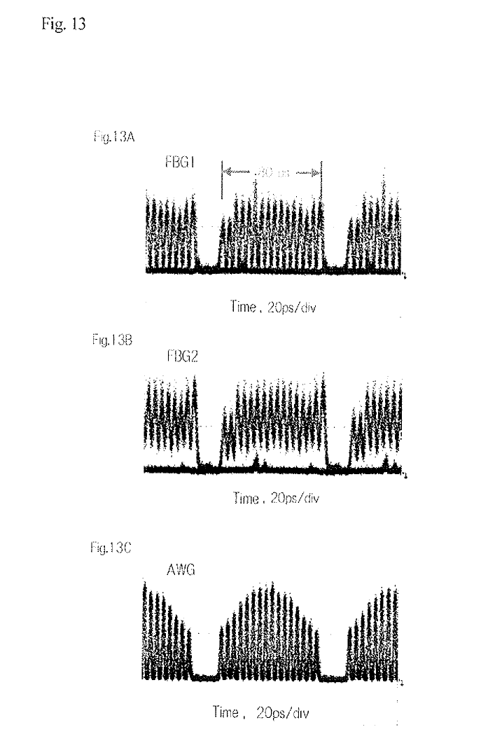

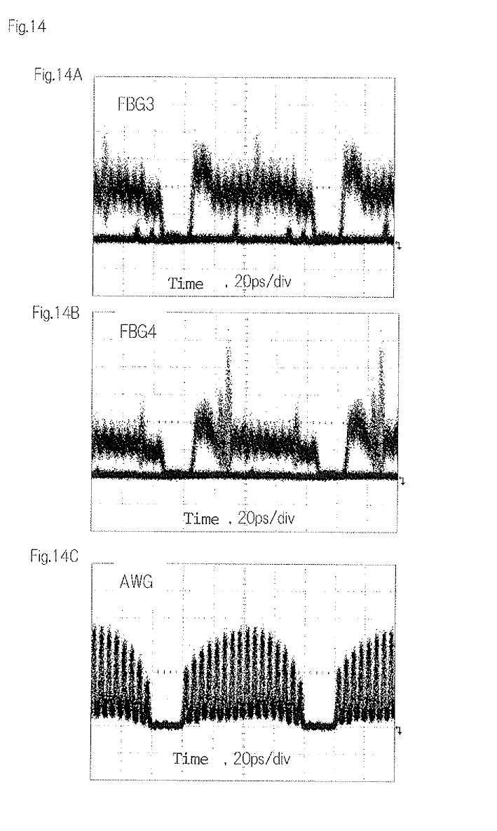

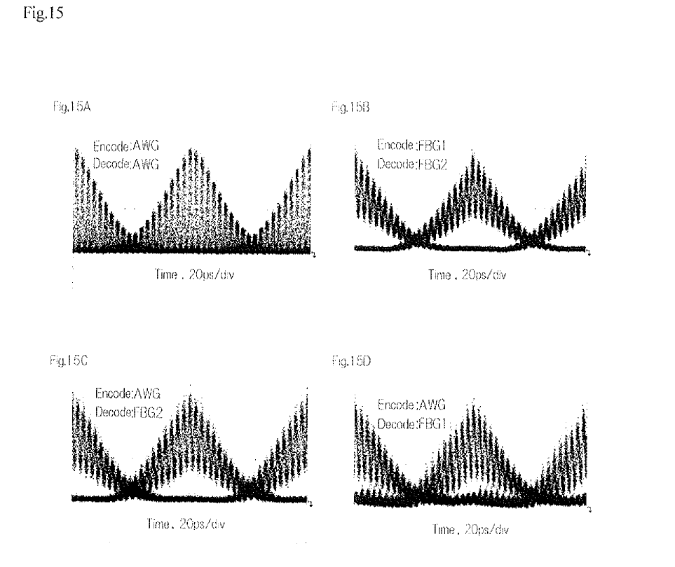

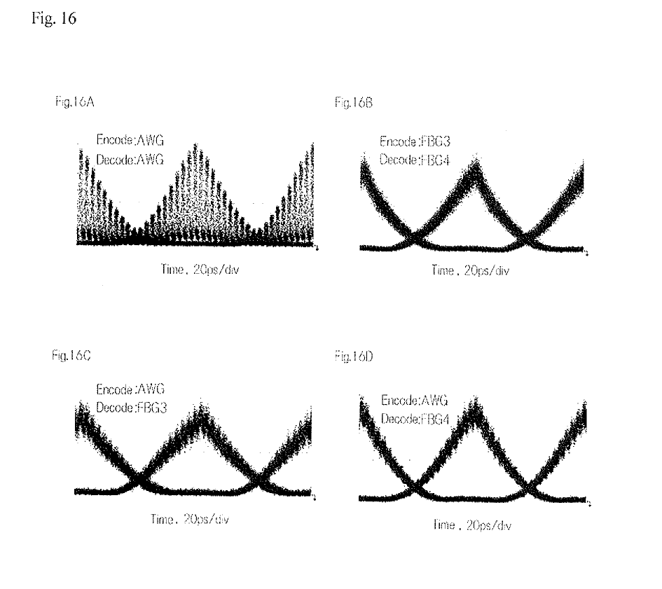

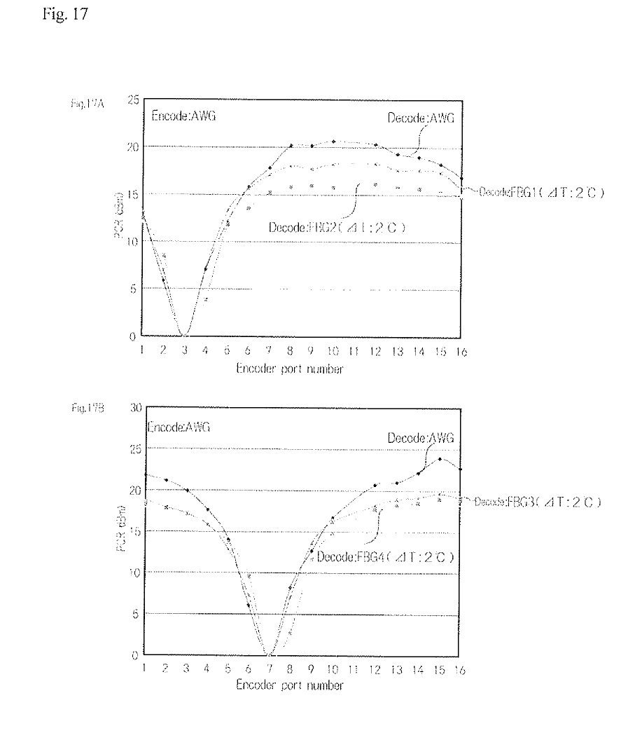

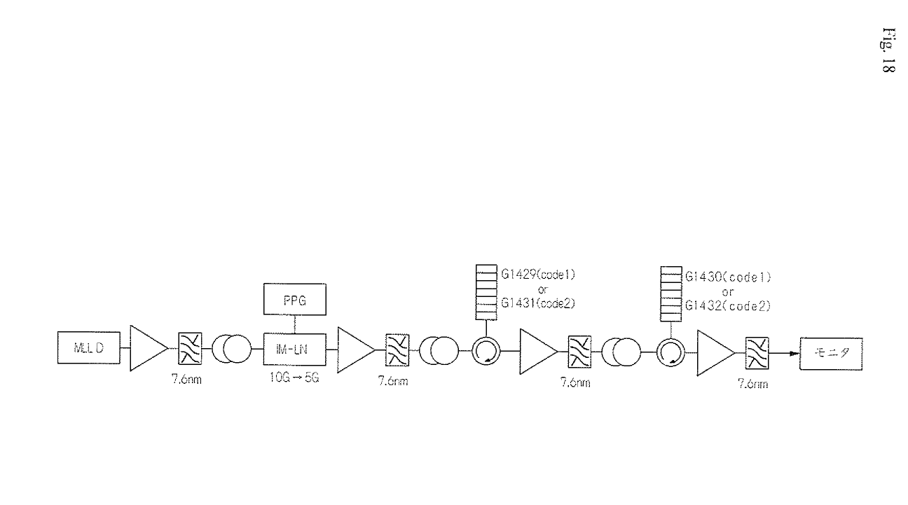

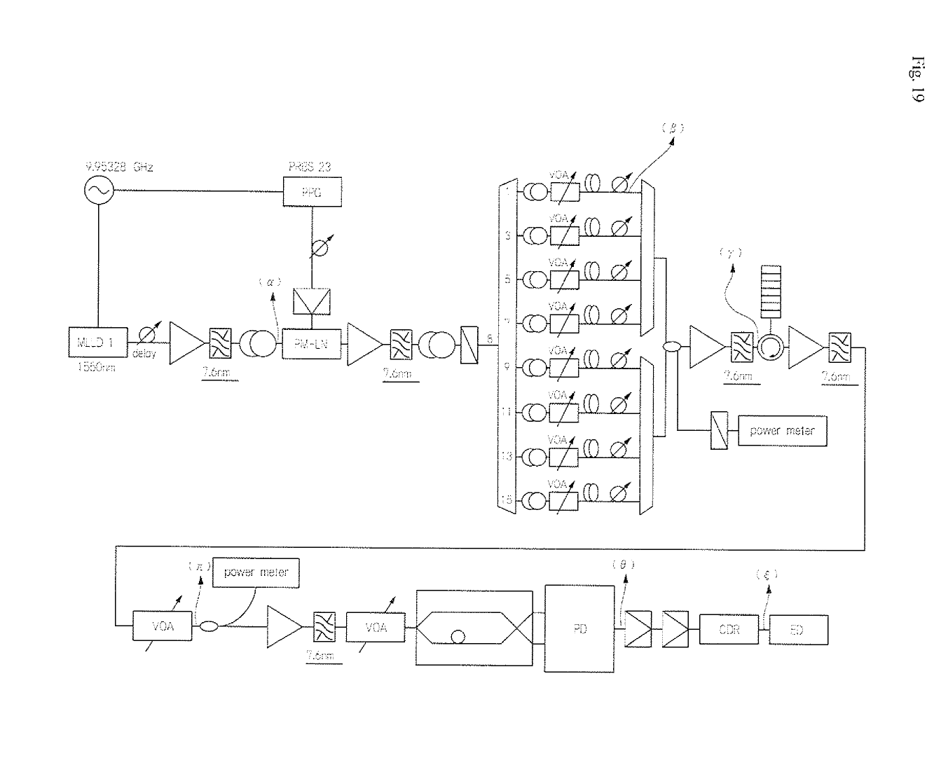

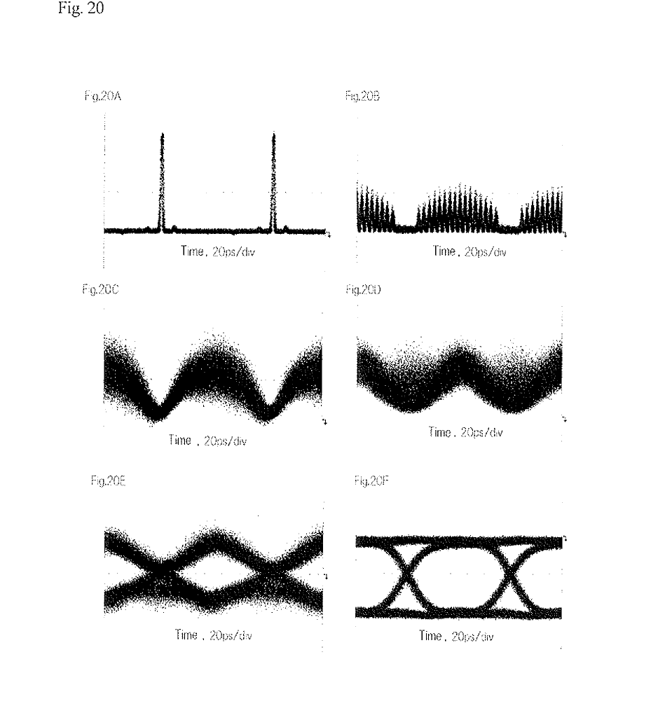

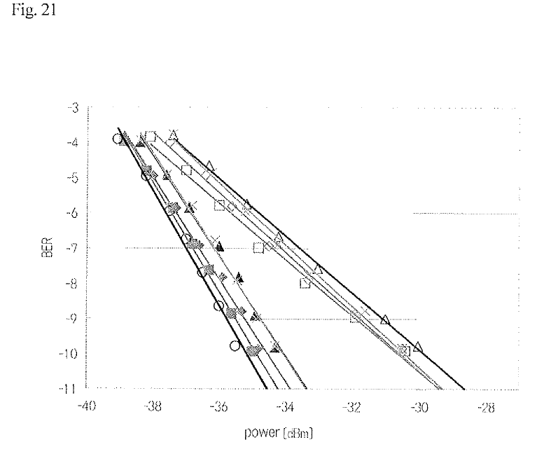

### EXPLANATION OF ELEMENT NUMERALS

1 a multi-port optical encoder
2 a central office
3 a decoder
4 a decode part
5 an optical code division multiple access system

1. An optical code division multiple access system comprising:
a central office which comprises a multi-port optical encoder; and
a decode part which comprises a decoder which decodes an optical signal encoded by the multi-port encoder,
wherein the multi-port optical encoder encodes an input optical signal into an optical code which is a coded optical signal, the wavelength of the coded optical signal being different at prescribed amount based on code pattern, and
wherein the decoder comprises a super structured fiber Bragg grating, SSFBG, which has a central wavelength based on corresponding coded optical signal.

2. The OCDMA system according to claim 1,
wherein the multi-port optical encoder comprises an array waveguide grating, AWG, and
wherein the AWG comprises:
pluralities of input ports;
an input slab coupler which is connected to the pluralities of input ports;
an output coupler, into which the optical signal from the input slab coupler enters;
pluralities of wave-guides, the length of the each of the wave-guide differs from each other at a prescribed amount; and
pluralities of output ports that are connected to the output coupler.

3. The OCDMA system according to claim 2,
wherein each of the plurality of wave-guides comprises core, the refractive index of the core being higher than that of clad which surrounds the core,
when the effective refractive index against the light that passes through the core of the wave-guide is nₛ, spacing between the pluralities of output ports and the output slab coupler is d₀ [μm], the spacing between the pluralities of wave-guides and the input slab coupler is d [μm], the center wavelength of the input optical signal is λ [nm], the number of output ports is N, the spacing between the pluralities of input ports and the input slab coupler is dᵢ [μm],
then dᵢ is equal to d₀, the spacing between pluralities of wave-guides and the pluralities of output slab coupler is also d [μm],
when R is the focal length of the input slab coupler, then the focal length of the output slab coupler is also R, and
λ, R, N, nₛ, d and d₀ meet the equation, λR=Nnₛdd₀.

4. The OCDMA system according to claim 1 or claim 2,
wherein the SSFBG comprises pluralities of chips, and
wherein the chips of the SSFBG have periodical phase difference between neighboring chips such that SSFBG can execute time spreading and phase shift for each of the optical code signal.

5. The OCDMA system according to claim 1 or claim 2,
wherein the SSFBG comprises pluralities of chips, and
wherein the pluralities of chips have phase so that they can selectively reflect the light that has close center wavelength corresponds to the optical code signal,
whereby the SSFBG can selectively reflect the light the wavelength thereof is closer the wavelength of the coded optical signal.

6. An optical code division multiple access system comprising:
a code part which has an encoder; and
a central office which comprises a multi-port optical decoder that decodes an optical signal encoded by the code part,
wherein the encoder comprises a super structured fiber Bragg grating, SSFBG, which has a central wavelength corresponds to the multi-port optical decoder,
wherein the multi-port optical decoder makes an input optical signal into optical signals, the wavelength of which is different at prescribed amount based on code pattern, and decode the optical signal encoded by the encoder.

7. The OCDMA system according to claim 6,
wherein the multi-port optical decoder comprises an array waveguide grating,
wherein the AWG comprises:
pluralities of input ports;
an input slab coupler which is connected to the plurality of input ports;
an output coupler, into which the optical signal from the input slab coupler enters;
pluralities of wave-guides, the length of the each of the wave-guide being configured to be different from each other at a prescribed amount; and
pluralities of output ports that are connected to the output coupler.

8. The OCDMA system according to claim 7,
wherein each of the plurality of wave-guides comprises core, the refractive index of the core being higher than that of clad which surrounds the core,
when the effective refractive index against the light that passes through the core of the wave-guide is nₛ, spacing between the pluralities of output ports and the output slab coupler is d₀ [μm], the spacing between the pluralities of wave-guides and the input slab coupler is d [μm], the center wavelength of the input optical signal is λ [nm], the number of output ports is N, the spacing between the pluralities of input ports and the input slab coupler is dᵢ[μm],
then dᵢ is equal to d₀, the spacing between pluralities of wave-guides and the pluralities of output slab coupler is also d [μm],
when R is the focal length of the input slab coupler, then the focal length of the output slab coupler is also R, and
λ, R, N, nₛ, d and d₀ meet the equation, λR=Nnₛdd₀.

9. The OCDMA system according to claim 6 or claim 7,
wherein the SSFBG comprises pluralities of chips, and
wherein the chips of the SSFBG have periodical phase difference between neighboring chips such that SSFBG can execute time spreading and phase shift for each of the optical code signal.

10. The OCDMA system according to claim 6 or claim 7,
wherein the SSFBG comprises pluralities of chips, and
wherein the pluralities of chips have phase so that they can selectively reflect the light that has close center wavelength corresponds to the optical code signal,
whereby the SSFBG can selectively reflect the light the wavelength thereof is closer the wavelength of the coded optical signal.
